(19) United States
(12) Patent Application Publication
(10) Pub. No.: US 2021/0381447 A1
(43) Pub. Date: Dec. 9, 2021

(54) DUAL-FUEL SUPPLY SYSTEM FOR DIRECT INJECTION

(71) Applicant: LANDI RENZO S.P.A., 42025 CAVRIAGO (REGGIO EMILIA) (IT)

(72) Inventors: EMANUELE VINCENZI, FORMIGINE (IT); ERCOLE SANGREGORIO, CAVRIAGO (IT)

(21) Appl. No.: 17/285,835

(22) PCT Filed: Oct. 2, 2019
(86) PCT No.: PCT/IB2019/058372

§ 371 Date: Apr. 15, 2021

(30) Foreign Application Priority Data
Oct. 24, 2018 (IT) 102018000009743

(51) Int. Cl. F02D 19/06

(52) U.S. Cl. CPC F02D 19/0628; F02D 19/0605; F02D 19/0647; F02D 2200/0602; F02D 19/0681; F02D 19/0689; F02D 19/0694; F02D 19/0678

(57) ABSTRACT

A dual-fuel supply system (100) for direct injection for engines of heavy vehicles, comprising: a supply line of a combustible liquid (160); a supply line of a combustible gas (170); a plurality of injectors (150) in fluid communication with the supply line of the combustible liquid (160) and with the supply line of the combustible gas (170); a pressure regulator device (1) for regulating the combustible gas; an electronic control unit (ECU) configured to control the supply of combustible liquid and of the combustible gas to the injectors (150), the electronic control unit (ECU) being configured to control the pressure regulator device (1) to track a reference pressure (p_{target}) according to a feedback logic.

### TECHNICAL FIELD

The present invention refers to a dual-fuel supply system for direct injection.

### PRIOR ART

The invention can be used, for example, in direct injection dual-fuel supply systems for heavy vehicles, such as lorries, buses, compactors and, in general, vehicles with engine capacities over 3 litres.

More generally, the invention can be used in systems that use gas with direct injection.

The reference technology is known as “dual-fuel” and consists of the simultaneous injection into a combustion chamber of two fuels: a liquid fuel, e.g. diesel, which has the purpose of triggering combustion, and natural gas, which is used for most of the injection (up to 95%). In this area, Westport has developed a system known as HPDI, an acronym for “High-Pressure Direct Injection”, based on double channel injectors, i.e. that can inject both diesel and natural gas. FIG. 1 schematically illustrates an HPDI system according to the prior art.

The liquefied natural gas, contained in a tank 10 on board the vehicle, has its pressure increased by means of a pump 11 and is brought to the gaseous state by a vaporizer 12. The vaporized gas is thus accumulated at about 300-320 bar in a compressed gas storage tank, indicated by number 13. The compressed gas passes through a pressure reducer 14 which reduces its pressure to within the range of about 140-290 bar in order to make it suitable for injection by a double channel injector 15. Such double channel injector 15 is supplied both by a diesel supply line, indicated with number 16, and a gas supply line, indicated with number 17, which is connected to the outlet of the pressure reducer 14.

As can be noted in FIG. 1, the gas pressure reducer 14 has two inlets: one for the combustible gas coming from the tank 13 and one for the diesel fuel connected to the diesel supply line 16. In other words, there is a fluid connection between the pressure reducer 14 and the diesel supply line 16.

The main advantage of such solution is to accompany the high performance of a diesel engine with a significant reduction in pollutant emissions (particulate, nitrogen oxides, carbon dioxide).

In this context, the attention is focused on the pressure reducer. In the state of the art for HPDI systems, the pressure reducer is a device that can lower the pressure of the gas in response to diesel pressure variations. Within the pressure reducer, the regulation of the gas pressure is therefore actuated purely mechanically, i.e. as a function of a balance of forces. Furthermore, as already mentioned above, such pressure reducer is characterized by a pneumatic connection between the two supply lines, i.e. diesel and gas, with risks of mixing the two fuels and leaks and, therefore, poor reliability. Furthermore, such solution does not allow strategies to be implemented that envisage regulating the pressure of the two fuels independently.

Document WO 2016/197252 exemplifies the solution described above. In this context, the technical task underlying the present invention is to provide a direct injection dual-fuel supply system, which obviates the drawbacks in the prior art as described above.

### OBJECT OF THE INVENTION

In particular, an object of the present invention is to provide a dual-fuel supply system for direct injection, which is more reliable and safe with respect to the solutions of the prior art.

Another object of the present invention is to provide a dual-fuel supply system for direct injection, which has a simplified structure with respect to the solutions of the prior art.

The defined technical task and the specified objects are substantially reached by a dual-fuel supply system for direct injection for engines for heavy vehicles, comprising:
a supply line of a combustible liquid;
a supply line of a combustible liquid;
a plurality of injectors in fluid communication with the supply line of the combustible liquid and with the supply line of the combustible gas;
an electronic control unit configured to control the supply of the combustible liquid and of the combustible gas to the injectors;
a pressure regulator device comprising a means for establishing a selective communication between an inlet channel and an outlet channel, the pressure regulator device being configured to receive combustible gas at an inlet pressure pin through the inlet channel and, in response to a command signal coming from the electronic control unit, dispense the combustible gas from the outlet channel to the supply line of the combustible gas with an outlet pressure pout lower than the inlet pressure pin;
a first pressure transducer configured to detect the pressure of the combustible gas in the corresponding supply line and to provide to the electronic control unit a first signal that is representative of the pressure detected for the combustible gas;
a second pressure transducer configured to detect the pressure of the combustible liquid in the corresponding supply line and to provide to the electronic control unit a second signal that is representative of the pressure detected for the combustible liquid.;

Advantageously, the electronic control unit is configured to generate the command signal in response to the first signal and to the second signal according to a feedback logic wherein the outlet pressure pout of the pressure regulator device of the combustible gas tracks a reference pressure p_{target}.

Advantageously, the means for establishing the selective communication between the inlet channel and the outlet channel comprise an electro valve configured to receive a command signal that is a function at least of a first pressure value pi of the combustible gas detected in the outlet channel.

Preferably, the system also comprises a third pressure transducer configured to detect the pressure of the combustible gas in the inlet channel and to provide to the electronic control unit a third signal that is representative of the pressure detected for the combustible gas.

According to one embodiment, the command signal is also a function of a second pressure value p₂ detected for the combustible liquid.

According to one embodiment, the command signal is also a function of a third pressure value p₃ detected of the combustible gas detected in the inlet channel.

Preferably, the electro valve is of the proportional type.

Preferably, the electro valve comprises:
a valve body provided with a hole interposed between the inlet channel and the outlet channel;
a shutter housed in the hole;
a solenoid operatively active on the shutter to move it within the hole in such a way that it assumes a position for which the flow rate of the combustible gas passing through the hole is proportional to the current that flows in the solenoid.

Preferably, the pressure regulator device also comprises:
a discharging channel;
a venting valve placed on the discharging channel and configured to establish the selective communication between the discharging channel and said outlet channel.

Preferably, on the inlet channel there is a shut-off valve.

### BRIEF DESCRIPTION OF THE DRAWINGS

Further characteristics and advantages of the present invention will become more apparent from the indicative and thus non-limiting description of a preferred but non-exclusive embodiment of a dual-fuel supply system for direct injection, as illustrated in the attached drawings, in which:

FIG. 1 schematically illustrates a dual-fuel supply system for direct injection with, according to a known solution;

FIGS. 2a to 2c schematically illustrate three embodiments of a dual-fuel supply system for direct injection, according to the present invention;

FIGS. 3-4 illustrate a pressure regulator device for regulating a combustible gas used in the direct injection dual-fuel supply system, in two different sectioned perspective views.

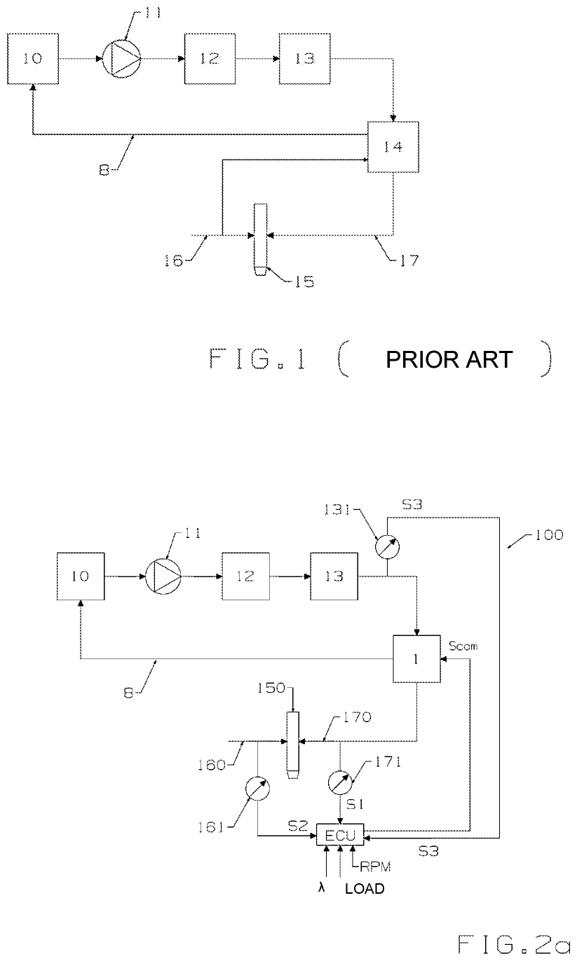

### DETAILED DESCRIPTION OF PREFERRED EMBODIMENTS OF THE INVENTION

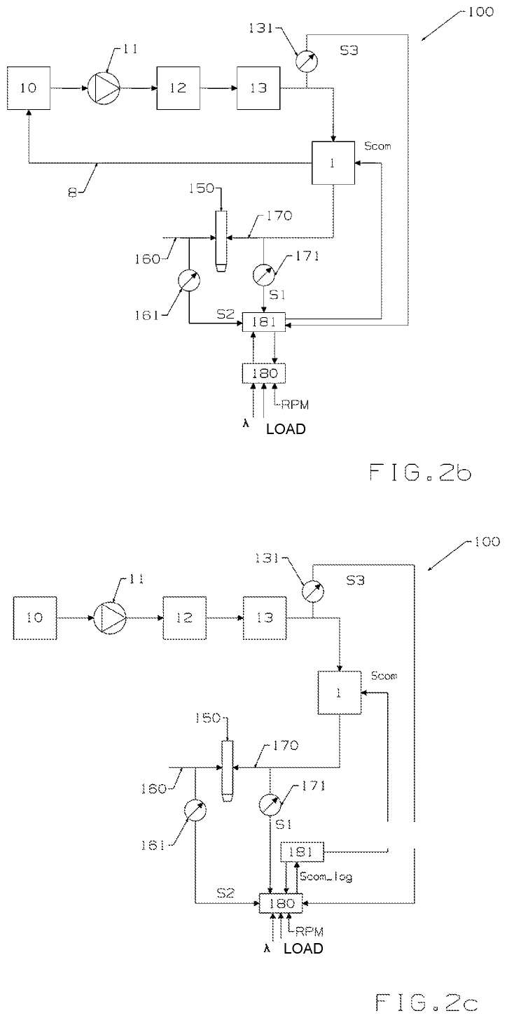

With reference to FIGS. 2a-2b, number 100 indicates a dual-fuel supply system for direct injection, in particular for engines of heavy vehicles, i.e. for vehicles with engines typically with a capacity greater than 3 litres.

The dual-fuel supply system 100 comprises:
a supply line 160 of a combustible liquid, in particular diesel (indicated below for simplicity purposes as “diesel line”);
a supply line 170 of a combustible gas, in particular natural gas (indicated below for simplicity purposes as “gas line”);
a plurality of dual channel injectors 150.

In particular, the dual channel injectors 150 are configured to simultaneously inject diesel and natural gas into a combustion chamber (not illustrated) of the engine.

Such injectors are of the known type and will not be described further. The dual-fuel supply system 100 comprises a pressure regulator device for regulating the pressure of the combustible gas, such device being indicated with number 1.

The components upstream of the pressure regulator device 1 are identical to those of the prior art.

In particular, with reference to FIGS. 2a-2b, the following are identified:
a first tank 10 containing liquefied natural gas;
a pump 11 downstream of the first tank 10;
a vaporizer 12 for making the liquefied natural gas evaporate;
a second tank 13 containing the vaporized natural gas.

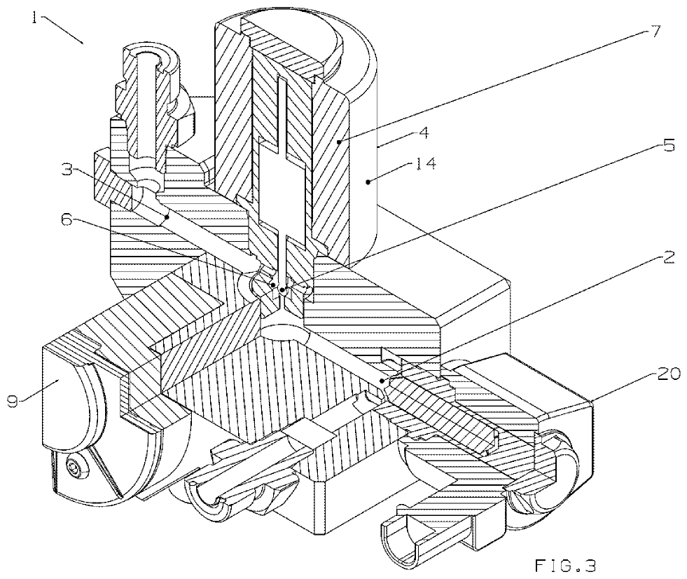

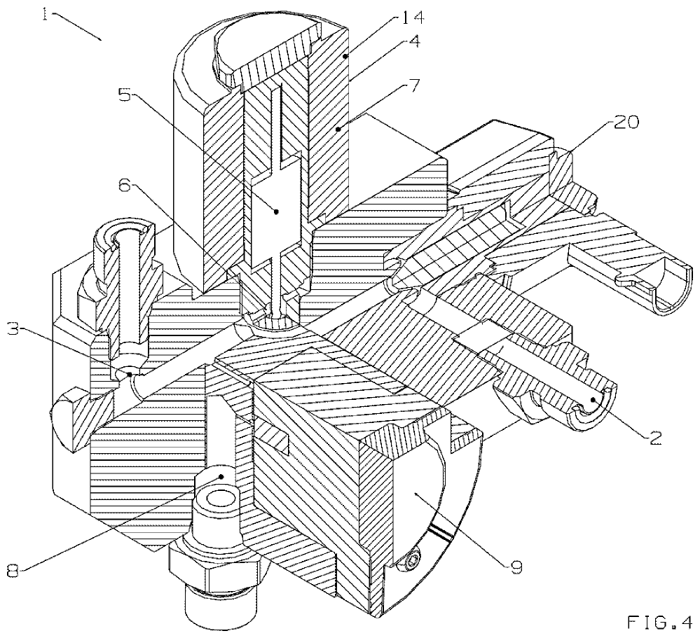

As can be noted from FIGS. 3-4, the pressure regulator device 1 of the combustible gas comprises:
an inlet channel 2 configured to receive the combustible gas at an inlet pressure pᵢₙ;
an outlet channel 3 configured to dispense the combustible gas at an outlet pressure pₒᵤₜ lower than the inlet pressure pin;
an electro valve 4 interposed between the inlet channel 2 and the outlet channel 3, which is configured to establish selective communication between such channels 2, 3.

According to one embodiment, the inlet pressure pᵢₙ is comprised between 300-320 bar and the outlet pressure pout between 140-290 bar.

According to another embodiment, the inlet pressure pᵢₙ is greater than 500 bar and the outlet pressure pout can reach up to 490 bar.

The electro valve 4 is configured to receive a command signal S_{corn} which is a function at least of a first pressure value p₁ of the combustible gas detected in the outlet channel 3, which is connected to the gas line 170.

According to the embodiment illustrated in FIGS. 2a and 2b, the command signal S_{corn} is also a function of a second detected pressure value p₂ of the combustible liquid detected in the diesel line 160. Preferably, the command signal S_{corn} is also a function of a third detected pressure value p₃ of the combustible gas detected in the inlet channel 2.

The dual-fuel supply system 100 comprises an electronic control unit ECU, which is configured to control the supply of the combustible liquid and of the combustible gas to the dual channel injectors 150.

The command signal S_{corn} for the electro valve 4 is generated by the electronic control unit ECU.

In response to the command signal S_{corn}, the pressure regulator device 1 dispenses the combustible gas at the outlet pressure pₒᵤₜ.

The system 100 comprises at least one first pressure transducer 171 configured to detect the pressure of the combustible gas (indicated above as “first pressure p₁”) in the corresponding gas line 170 and to provide to the electronic control unit ECU a first signal Si representative of such pressure.

In the embodiment illustrated in FIGS. 2a and 2b, the system 100 also comprises a second pressure transducer 161 configured to detect the pressure of the diesel (indicated above as “second pressure p₂”) in the corresponding diesel line 160 and to provide to the electronic control unit ECU a second signal S₂ representative of such pressure.

Preferably, there is also a third pressure transducer 131 configured to detect the pressure of the combustible fuel (indicated above as “third pressure p3”) in the inlet channel 2 and to provide to the electronic control unit ECU a third signal S3 representative of such pressure.

The electronic control unit ECU is configured to generate the command signal S_{corn} in response at least to the first signal S₁.

Preferably, the electronic control unit ECU is configured to generate the command signal S_{corn} also in response to the second signal S₂ and to the third signal S₃ according to a feedback logic such for which the outlet pressure pₒᵤₜ of the combustible gas from the pressure regulator device 1 tracks a reference pressure p_{target}.

The reference pressure p_{target} can vary as a function of the engine operating conditions.

The feedback logic implemented by the electronic control unit ECU for generating the command signal S_{corn} perfectly considers also engine parameters such as, for example:
revolutions per minute (RPM)
lambda λ (AFR, air fuel ratio)
engine load (aspirated air flow rate).

As can be understood from the figures and the above explanation, it is not necessary to bring the combustible liquid directly to the pressure regulator device 1, which instead only responds to the command signal S_{corn}.

FIG. 2a relates to an embodiment in which the electronic control unit ECU is a single electronic module that acquires the engine parameters and the three signals mentioned above S₁, S₂, S₃ and generates the command signal S_{corn}.

FIG. 2b relates to a variant in which the control unit ECU comprises two distinct modules: a first electronic module 180 which acquires the engine parameters and sends them to a second electronic module or driver 181 (that can possibly be integrated into the pressure regulator device 1) which receives as inputs also the three signals S₁, S₂, S₃ mentioned above and generates the command signal S_{corn}.

FIG. 2c relates to a further variant in which the control unit ECU comprises two distinct modules: a first electronic module 180 which acquires the engine parameters and which receives the three input signals mentioned above S₁, S₂, S₃ and generates a control logic signal S_{com_log} to be sent to a second electronic module or driver 181 (that can possibly be integrated into the pressure regulator device 1) which generates the command signal S_{corn}.

Preferably, the electro valve 4 is of the proportional type. In particular, it comprises:
a valve body 14 inside which a hole 6 is obtained, interposed between the inlet channel 2 and the outlet channel 3;
a shutter 5 housed in the hole 6;
a solenoid 7 operatively active on the shutter 5 to move it within the hole 6 in such a way that it assumes a position for which the flow rate of the combustible gas passing through the hole 6 is proportional to the current that flows in the solenoid 7.

The pressure regulator device 1 also comprises a discharging channel 8 with which a venting valve 9 is associated to establish the selective communication of the discharging line with the outlet channel 3. In that case, there are two control signals, one for the electro valve 4 and the other for the venting valve 9. In general, there may be various control signals present if there are various valves to be controlled in the device 1. In particular, when the outlet pressure pout of the combustible gas exceeds a predefined threshold, the venting valve 9 is opened, so as to enable the discharge of part or all of the combustible gas through the discharging channel 8.

The discharging channel 8 leads directly into the environment or into the first tank 10 containing the liquefied natural gas.

Preferably, there is a shut-off valve 20 on the inlet channel 2 which represents a safety valve configured to interrupt the fluid communication between the inlet channel 2 and the outlet channel 3 in response to certain operating conditions of the system 100.

For example, the shut-off valve 20 intervenes in the event of the engine being turned off, or when the system operates only with diesel or in the event of an accident.

From the description provided the characteristics of the dual-fuel supply system for direct injection according to the present invention are clear, as are the advantages.

As the supply system proposed performs electronic regulation of the gas pressure the fluid connection to the diesel supply line is eliminated. The injector supply system is more flexible as the regulator is instructed by the control unit to track a reference or target pressure that may be variable (unlike what happens in completely mechanical solutions).

1-8. (canceled)

9. A dual-fuel supply system (100) for direct injection for engines of heavy vehicles, comprising:
a supply line of a combustible liquid (160);
a supply line of a combustible gas (170);
a plurality of injectors (150) in fluid communication with the supply line of the combustible liquid (160) and with the supply line of the combustible gas (170);
an electronic control unit (ECU) configured to control the supply of the combustible liquid and of the combustible gas to said injectors (150);
a pressure regulator device (1) comprising a means for establishing a selective communication between an inlet channel (2) and an outlet channel (3), said pressure regulator device (1) being configured to receive combustible gas at an inlet pressure (pin) through said inlet channel (2);
a first pressure transducer (171) configured to detect the pressure of the combustible gas in the corresponding supply line (170) and to provide to said electronic control unit (ECU) a first signal (51) that is representative of the pressure detected for said combustible gas;
a second pressure transducer (161) configured to detect the pressure of the combustible liquid in the corresponding supply line (160) and to provide to said electronic control unit (ECU) a second signal (S2) that is representative of the pressure detected for said combustible liquid,
characterised in that said electronic control unit (ECU) is configured to generate a command signal (Scom) in response to the first signal (51) and to the second signal (S2) according to a feedback logic wherein the outlet pressure (pout) of the pressure regulator device (1) tracks a reference pressure (ptarget), said means for establishing the selective communication comprising an electro valve (4) configured to receive the command signal (Scom),
said pressure regulator device (1) being configured to dispense the combustible gas from the outlet channel (3) to the supply line of the combustible gas (170) with an outlet pressure (pout) lower than the inlet pressure (pin) in response to said command signal (Scom).

10. The dual-fuel supply system (100) according to claim 9, further comprising:
a third pressure transducer (131) configured to detect the pressure of the combustible gas in said inlet channel (2) and to provide to said electronic control unit (ECU) a third signal (S3) that is representative of the pressure detected for said combustible gas.

11. The dual-fuel supply system (100) according to claim 9, wherein said command signal (Scom) is also a function of a third pressure value p3 of the combustible gas detected in the inlet channel (2).

12. The dual-fuel supply system (100) according to claim 9, wherein said electro valve (4) is of the proportional type.

13. The dual-fuel supply system (100) according to claim 12, wherein said electro valve (4) comprises:
a valve body (14) provided with a hole (6) interposed between the inlet channel (2) and the outlet channel (3);
a shutter (5) housed in said hole (6);
a solenoid (7) operatively active on said shutter (5) to move it within said hole (6) in such a way that the shutter (5) assumes a position in which the flow rate of the combustible gas passing through the hole (6) is proportional to the current that flows in the solenoid (7).

14. The dual-fuel supply system (100) according to claim 9, further comprising:
a discharging channel (8);
a venting valve (9) placed on the discharging channel (8) and configured to establish the selective communication between said discharging channel (8) and said outlet channel (3).

15. The dual-fuel supply system (100) according to claim 9, further comprising a shut-off valve (20) placed on said inlet channel (2).
